(19) United States
(12) Patent Application Publication
(10) Pub. No.: US 2015/0076781 A1
(43) Pub. Date: Mar. 19, 2015

(54) Skateboard Formed of Unitary Structure

(71) Applicants: Devin O'Dea, La Jolla, CA (US); Alex Jones, Encinitas, CA (US); Malcolm Jones, Encinitas, CA (US)

(72) Inventors: Devin O'Dea, La Jolla, CA (US); Alex Jones, Encinitas, CA (US); Malcolm Jones, Encinitas, CA (US)

(21) Appl. No.: 14/030,849

(22) Filed: Sep. 18, 2013

(51) Int. Cl. A63C 17/01; B29C 43/18; A63C 17/26

(52) U.S. Cl. CPC A63C 17/017; A63C 17/26; B29C 43/18; B29L 2031/003
USPC 280/87.042; 264/154

(57) ABSTRACT

A skateboard and method of forming such a skateboard is provided which yields a skateboard deck, formed in a unitary structure, of polymeric material. The deck may formed of molten, pliable, planar sheet material, which is heated past a glass transition temperature and thereafter formed for curves and shape through imparting of force on the polymeric material by molding. The resulting skateboard deck is formed as a unitary structure which can be further enhanced using flexible compressible mounts engaged in deck apertures to engage the wheels and trucks thereon. The unitary structure of polymeric material is also well suited for light transmission therethrough from light emitters which may be operatively engaged to the mounts.

### BACKGROUND OF THE INVENTION

1. Field of the Invention

The present invention relates generally to skateboards. More particularly the invention relates to the forming of skateboard decks as a unitary structure such as polycarbonate, through thermoforming, or compressive or injection molding, and enhanced with a means for compressively engaging conventional skateboard truck assemblies thereto. The disclosed device forming a skateboard deck from formable plastics or polymeric material is provided a means for engagement to wheel trucks which is non-damaging to the formed deck. The method of molding heated plastic or polymeric materials for forming skateboard decks allows manufacturers to achieve new performance characteristics in skateboard deck design, shapes, material composition, strength, and flexibility, allowing for innovations which cannot be accomplished with conventional wooden skateboard decks.

2. Prior Art

Conventional skateboards comprise wood laminate decks with metal truck assemblies which are secured by threaded metal nut and bolt hardware. The skateboard deck and baseplate of the truck assembly conventionally employ a plurality of drilled or preformed clearance apertures which allow the user to communicate a plurality of bolts therethrough to secure the truck and deck together by the secured threaded engagement of the nuts to the bolts. The top surface of the deck typically includes countersinks to receive the heads of the bolts such that the bolts lie flat with the surface of the deck, without protruding.

The manufacture of skateboard decks from wood laminate has been the convention for many years and for many reasons. Wood is inexpensive, lightweight, and can be formed with the desired concave and curvature. The laminate construction provides an adequately rigid support surface for the rider while maintaining some flexibility due to the fibrous wood material. In the manufacture process, wood decks can be easily drilled to obtain the proper clearance apertures for the securing hardware.

However, many drawbacks are also known. Firstly, wood decks are often subject to cracking or splitting when under impact stresses of the rider performing extreme maneuvers. Factors leading to failure of the deck can be further complicated due to deficiencies in the wood itself, which may not be known to the manufacture simply upon a visual inspection.

Further, wooden decks are often subject to cracking or splitting in the area where the trucks engage the deck, due to concentrated compressive engagement forces communicated from the heads of the bolts onto the top surface of the deck when securing the trucks thereto. Decks are especially subject to such cracking if the securement hardware is inadvertently over tightened by the user. Further, like most wood products, wooden decks tend to dry out, causing the wood fibers to become stiff and brittle, such that the deck can no longer sufficiently absorb and distribute the compressive force of each bolt head through a larger surface of the board. Thus, the drilled clearance holes are often a location subject to failure due to the concentrated stress points of engagement with each bolt head. Finally because of the characteristics and method of laminated deck manufacture, the forming of decks with multiple angular surfaces is extremely hard to achieve when using wood laminates.

Because of these and other inherent drawbacks, prior art has shown many attempts to provide skateboards of otherwise non-conventional materials, such as plastics and metals. The use of non-conventional materials are desired for many reasons. These polymeric and plastic and synthetic materials, especially plastics and polycarbonate in particular, could help manufacturers to substantially reduce manufacturing costs, since plastic forming techniques such as injection molding, and heated press molding disclosed herein, can yield compound angles in deck surfaces and can be accomplished relatively quickly and easily, compared to wood decks which require generally separate cutting, laminating, and shape forming processes.

Further, plastics additionally allow designers to create new and improved shapes, designs, and employ material having flexure and strength properties not previously achievable with wood materials, in order to increase strength and flexibility, and overall can improve the riding performance. Examples are shown in U.S. Pat. Nos. 4,337,963, 6,293,571, 6,854,748, others. These devices attempt in vain to successfully achieve these goals, because there exists some unfortunate downfalls noted with these and similar devices.

Additionally, with the use of nut and bolt hardware being convention in the art, the result is that the plastic or other material deck must also be adapted for receiving such hardware. As such art concerning existing plastic or metal decks will similarly employ drilled or pre-formed apertures communicating through the deck as needed or receiving truck securement nut and bolt hardware in a conventional engagement as outlined above. However, unlike fibrous wood decks, decks formed of multiple plastic components, and metal materials, frequently fail to distribute the concentrated forces of the bolt heads through the deck surface.

As such, many conventional layered plastic and metal formed decks are often subject to cracking and splitting at the locations of concentrated engagement of the bolt heads with the surface of the deck, even in instances where the hardware is properly tightened.

However, the use of plastics such as polycarbonate, to form skateboard decks as single unitary structures, which allows for forming compound angular surfaces, is still highly sought in the art. As noted, unitary structured decks formed of plastics allow designers to create shapes, designs, and configurations which are otherwise unachievable with conventional wooden decks. Further, plastic unitary decks will allow for the customization of material properties which allows manufacturers to produce decks having strength, flexibility, and other material properties which are highly customizable as needed for achieving various performance characteristics.

As such, there is a continuing unmet need for a method and device yielding skateboard decks formed in a unitary structure from plastic or polymeric material such as polycarbonate, which when molded using heat, yields decks formed in a unitary structure with multiple traverse or parallel angular surfaces. As a means to further enhance the formed decks, a means for engaging conventional truck assemblies to such formed skateboard decks, using conventional hardware will provide an enhanced truck and wheel engagement. The engagement disclosed herein, provides a means for separation of the compressive securing forces of the nut and bolt hardware upon a formed skateboard deck. This separation and buffering of such engagements helps ensure that the plastic such as polycarbonate deck, resists cracking and splitting of the deck when the wheels and trucks communicate impact forces of a rider.

Such a device and method should allow manufacturers to use plastics and in particular polycarbonate, and other materials which are rendered pliable when heated, for forming skateboard decks. Such deck formation in unitary structures would be formable without the fear of the finished deck cracking or splitting when engaging trucks using conventional hardware. Such a device would therefor allow manufacturers to use new and innovative plastics and other materials for forming skateboard decks with multiple angular surfaces and having material properties previously unusable due to the noted drawbacks of conventional securing methods of truck assemblies.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device and method of formation for skateboard decks formed in unitary structures with angular surfaces, herein disclosed and described provides a solution to the shortcomings in prior art. The method of formation and the device so assembled, achieves the above noted goals through the provision of a skateboard deck formed in a heat formation method, which may be combined with a unique means for engaging conventional skateboard truck assemblies using conventional hardware to the formed skateboard decks, be they from plastic such as polycarbonate, plastic composites, and plastic laminates, and the like. The unitary deck structures so formed when engaged with trucks and wheels with the interface herein, resist cracking or splitting of the formed deck at the engagement of the hardware with the deck.

The skateboard deck formed as a unitary structure by the method herein, may also employ a novel mount as a means for engagement of trucks and mounting hardware which is non damaging to the deck. In at least one preferred mode, the mounting component for the formed device advantageously distributes the compressive engagement force of the hardware to the deck in a manner which resists a cracking, splitting, and other wear to the deck which is commonly seen with conventional engagement methods and decks formed in layers or of components bolted together. Thus, the present invention facilitates the use of heat formable materials such as plastic and in particular polycarbonate, and also metals, or combinations thereof as skateboard decks. Employing the formation method herein, it will allow designers and manufacturers to customize the structural characteristics of the deck to have multiple parallel and/or traverse angular surfaces. This yields performance characteristics previously unachievable due to the conventional cracking or splitting of conventional laminate or other non unitary deck structures, which tend to occur at the engagement of the bolt hardware to the deck.

In accordance with at least one preferred mode, the device includes a deck formed by the method herein, and a means for engagement of conventional truck assemblies employing conventional hardware provided by a pliable top support member and a bottom support member. The support members are preferably planar, with the top member intended to engaged the top surface of the deck, and the bottom member intended to engage the bottom surface of the polymer, plastic, or polycarbonate deck, with the deck in a sandwiched engagement therebetween. The members include a plurality of spaced apertures configured in spacing and pattern to receive bolt hardware in a conventional pattern for engaging conventional truck assemblies.

Unlike wooden and plastic decks multi-layer decks known in the art employing a plurality of clearance apertures for receiving bolt hardware for each truck, the mounting component employable with the formed deck of the present invention preferably includes apertures on the unitary formed decks, centrally positioned in the conventional locations for engaging the trucks. The apertures are defined by a circumferential edge which is sized and shaped to allow for the communication of a conventional array of bolt hardware to extend there through without physical contact of the bolts for the trucks with the deck itself.

For two wheels sets and two trucks, the mounting system generally includes a front aperture and a rear aperture, disposed in the deck formed by the method herein, in conventional locations where trucks are engaged. Thus, the truck assembly is secured with conventional hardware communicated through the top and bottom support members, wherein the compressive engagement of the securing hardware is communicated the surface areas of contact of the support members to the deck, with the deck being in a sandwiched engagement between the members.

The circumferential edge of the apertures may communicate with an adjacent lip portions recessed from one or both of the top and bottom surfaces of the deck, providing a recessed surface area of contact with the top and bottom support members. This recessed lip, being positioned below the top and bottom surfaces of the deck, allows the top and bottom members to sit flush with the respective surface of the deck. Therefor the support members will not protrude from the surfaces of the deck, and is desired for rider safety reasons.

The support members can include a plurality of layers of material. In at least one preferred mode the support members include at least one layer of hard material, such as metal, and one layer of cushion material, such as plastic or rubber. However, other modes are envisioned wherein the support members are formed of three or more layers of material.

The present invention herein providing a method for formation of heat formable skateboard decks formed in a unitary structure, is enhanced using means for engagement of conventional skateboard trucks which is compressive and non-damaging, facilitates the use of plastic or composite materials for forming the deck, and will allow for additional and previously unachievable utility features to be carried out in the design and construction of the deck. For example, the deck can be constructed of a clear polycarbonate or acrylic material in a unitary structure by heating of the material at or above its glass transition temperature, rendering it formable, and submitting it to pressure formation. Upon cooling below the glass transition temperature the resulting unitary structure forming the deck from such heat formable material as polycarbonate, will form a substantially transparent unitary deck structure allowing for the inclusion of an illumination component and resulting communication of illumination from the light source, throughout the entire surface area of the unitary structure forming the deck. Illumination of at least one portion of the clear or transparent deck, will then cause like to disperse throughout the deck providing an illumination of at least a larger portion of the deck.

Further, the deck can be constructed from a plurality of different colored plastic laminates to achieve new and innovated design and coloring features. Still further, the device herein facilitates the manufacture, and use of the decks, constructed from plastics or composites having strength and flexibility characteristic provided new and innovative material compositions, which may have until now been deemed too brittle or insufficient for conventional securement methods, can be easily employed using the components and features of the present invention for securing trucks.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is a particular object of this invention to provide a method for forming of heated plastic or polymeric material, of any thermoplastic or thermosetting polymer, into a unitary structure to form a skateboard deck.

It is an object of the invention to provide a means for engaging conventional truck assemblies to a skateboard deck which is compressive and non-damaging to the deck.

It is a further object of this invention to provide such a method to form decks which allows for parallel and traverse angular surfaces on a single formed deck.

It is an object of the invention to provide a means for engaging conventional truck assemblies to a skateboard deck which does not employ points of concentrated engagement of hardware to the deck.

It is another object of the invention to facilitate the employment of plastics, metals, composites, and combinations thereof in the manufacture and construction of skateboard decks.

It is another object of the invention to engage conventional truck assemblies to the skateboard deck using conventional hardware, wherein the deck is no longer subject to failure due to over tightening or increased stresses communicated from the location of engagement of the truck.

These and other objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a top view of a particularly preferred mode of the deck of the invention having front and rear apertures.

FIG. 2 shows a perspective view of the deck of FIG. 1.

FIG. 3 shows a cross sectional view of the deck of FIG. 1 viewed along line AA of FIG. 1.

FIG. 4 shows a top view of a preferred mode of the top support member for the front aperture, the bottom support member (not shown) being substantially identical.

FIG. 4a shows a side view of the top support member of FIG. 4.

FIG. 5 shows a top view of a preferred mode of the top support member for the rear aperture, the bottom support member (not shown) being substantially identical.

FIG. 5a shows an end view of the top support member of FIG. 5.

FIG. 6 shows a preferred cross section of top support member of FIG. 5 formed of a single layer.

FIG. 6a shows another preferred cross section of the top support having two layers of material.

FIG. 6b shows yet another preferred cross section of the top support having three layers of material.

FIG. 7 shows a perspective view of the invention showing the deck and top and bottom support members aligned with both front and rear apertures.

FIG. 8 shows a cross sectional view of the top and bottom support members engaged to the aperture showing the conventional hardware and baseplate of a truck assembly.

FIG. 9 shows a cross sectional view depicting the compressive engagement of the top and bottom support members engaging a conventional truck baseplate with the deck employing conventional nut and bolt fasteners.

FIG. 10 shows yet another mode of the device showing the engagement of an illumination component within at least one of the apertures of the deck for illuminating the deck.

FIG. 11 shows a cross sectional view of the deck depicting the illumination component engaged to the deck.

FIG. 12 shows the deck and illumination component in an as-used mode, for illuminating the deck.

FIG. 13 depicts a top view of a deck subsequent to heat compressive or thermoforming to a desired single, dual, or other camber and shape, with the mounts 13 engaged within the formed apertures.

FIG. 14 is a sectional view through a unitary formed mount which engages the apertures at a circumference showing truck engagement and lighting and power components common to both types of mount.

FIGS. 15-17 depict shapes achievable in a dual cambered deck using the system and mounts herein.

FIG. 18 shows a deck formable using the system and mounts herein having raised side edges and a substantially planar central section.

FIG. 19 is a perspective underside view of the FIG. 18.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Further, while shown as adapted to engage apertures formed in the thermoformed decks 12 herein, the mounts 13 and mounting system for trucks they afford, could be employed with conventional laminate decks 12 to provide adjustment for truck mounting and truck impact and vibration dampening to such decks 12 and such is anticipated as within the scope of this patent.

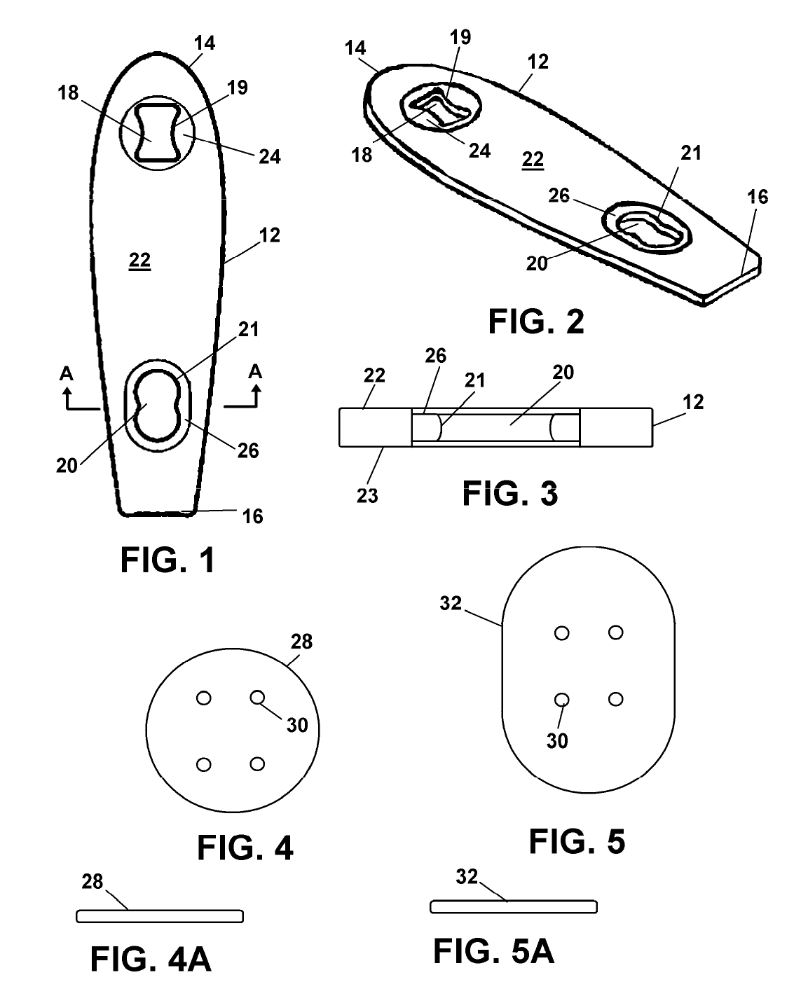

Now referring to drawings in FIGS. 1-12, wherein similar components are identified by like reference numerals, there is seen in FIG. 1 and FIG. 2 views of a particularly preferred mode of the deck 12 of the thermoformed skateboard device 10 (FIG. 7) generally having a front end 14 and a rear end 16.

The device 10 herein formed through the disclosed method for the formation of skateboard decks 12 as a unitary structure from polycarbonate or plastic or other materials which are formable to shape, when heated to a temperature approaching or above the material's glass transition temperature where the polymeric material becomes pliable or formable. In combination with the unitary structure formed as the deck 12 once the material cools below transition temperature, a mount 13 providing the compressive, and or flexible, and non-damaging engagement of conventional truck assemblies (baseplate 104 shown in FIG. 8), to the formed deck 12 may be provided.

The deck 12 is formable using polymeric material formed of any singular or mixture of thermoplastic or thermosetting polymeric material which when heated at or above its glass transition temperature, or close thereto, becomes pliable or flowable depending on the method of formation. A particular favorite polymeric material for use herein is polycarbonate, which is heated to the noted transition temperature point where it is pliable by force, or mold-formable, or may be thermoformed into the unitary structure forming the deck 12.

Upon being allowed to cool from the transition temperature, the unitary structure yielded forming the deck 12 in this fashion, yields a pressure-molded, injection-molded, or thermoformed deck 12, which is formed in an extremely strong unitary structure as opposed to conventional lamination of multiple layers. The unitary structure so formed my while heated and pliable be formed with compound angular surfaces and/or one or a plurality of parallel or traverse angular sections formed in the deck 12 in this fashion yielding enhanced performance and control.

In a method for forming the deck 12 through injection molding, the polymeric material comprising one or a mixture of any thermoplastic or thermosetting polymeric material, such as vinyl or polycarbonate, which is first heated above its glass transition temperature to a temperature where it will flow through a conduit. The flowable polymeric material is then injected under pressure into an injection mold cavity formed to yield the deck 12 with planar sections, raised sections, and curved portions in all modes depicted in the figures or described herein.

In a second method for forming the deck 12 using polymeric material such as polycarbonate, planar sheets of polymeric material are cut to blanks have a perimeter configured in the fashion of the completed deck 12. Thereafter the blanks of polymeric material are heated past their glass transition temperature to a point where the planar material is pliable under pressure. Next, the heated blanks are positioned between two opposing half sections of a mold. While still heated to a pliable state and positioned between the opposing half sections of the mold, the two opposing half sections are forced toward each other to engage the polymeric blank in a compressed sandwiched engagement. Separation of the mold halves and removal of the formed deck 12 follows whereafter the deck 12 cools. In this fashion the deck 12 may be formed with all the curves and planar sections and shapes shown herein.

In a third method of heated shape formation of the deck 12 herein, into a unitary structured deck 12, sheets of planar polymeric material are cut into blanks 12 having perimeters substantially similar to the final produced deck 12. The blanks are heated past the glass transition temperature of the polymeric material to a point where the planar sections are thermoformable. The blanks are then positioned adjacent to a mold which is in operative engagement with a vacuum or negative pressure source. Once adjacent to the mold, the pliable blank is subjected to the vacuum force and pulled against the mold surface thereby bending the blank to form the final deck 12. The blank is allowed to cool and maintain the final shape of the deck 12. All of the curves and planar sections described in the specification or shown in the drawings are producible in the unitary structure 12 forming the deck 12 in this manner.

Also, in combination with the deck 12 formed using heated to its temperature where it is pliable, formable, or pressure formable material, the skateboard deck 12 so formed may be combined with the disclosed compressive non-damaging truck mount providing an interface for mounting the trucks operatively to the deck 12. This truck mount provides a means for operatively engaging the bolts and base of a truck, in a compressive engagement with the formed plastic or polymeric or other thermoformed unitary structure deck 12, or even conventional wood laminate decks.

The mount, so engaged, provides a flexible yet sturdy interface between the mounting hardware of the trucks, and the deck 12. The mount engaged within apertures formed in the deck 12 of choice, alleviates the problems associated with hard landings on the wheels which would normally crack or split many decks 12 under stresses of the truck and mounting bolts during use. As such, the method for deck 12 formation and the truck mounting component yielding the device 10 herein, provides multiple utility in that it facilitates the use of materials such as plastics such as polycarbonate, and polymeric and other heatable deformable materials, or combinations thereof, to form decks 12 for skateboards with compound angled or cambered portions which are strong and eliminates such decks which heretofore were weak and easily cracked when engaged to trucks.

The formed deck 12 being a unitary structure formed with heated pliable material which cures solid, yields skateboard decks 12 which are especially strong, and which may be formed with multiple angled surfaces n the deck 12. Combined with the novel mounting system herein, the disclosed deck 12 or even conventional decks 12 when employed therewith, are insured against breakage from impacts of the rider by using inserts to provide engagement areas for the trucks. The mounting system as noted works especially well with the disclosed deck 12 formed by the method herein, and with conventional wood or metal or other decks 12.

The method for forming the decks 12 to unitary structures employs polymeric material such as polycarbonate, which is heated to its glass transition temperature which is a state where the material is pliable to imparted force, or it may be further heated where it will flow in conduits to molds. Thereafter using molds and force, or suction for thermoforming, or injection molding, a molded deck 12 formed as a unitary structure of the cooled polymeric material is yielded. The deck 12 formation method herein allows designers and manufacturers to customize performance characteristics of formed decks 12, to achieve previously unachievable shapes, spring, and rebound, by forming single and compound angular portions in a single formed deck 112.

When combined with the unique truck engagement system using the slightly compressible or pliable truck mounts, the operative skateboard yields a smooth ride from the dampening effect of the mounting material for the trucks, as well as a means to protect the deck 12 from cracking or shattering when the trucks impact a riding surface at an extreme force. This enhanced deck 12 construction and performance from unitary structures of plastic and polymeric materials, can be used in the system herein, due to the elimination of the conventional cracking or splitting of the deck 12, which conventionally can occur at the engagement of the bolt hardware (nuts and bolts 100, 102) to the deck 12 through the truck. A particularly preferred material for deck 12 formation is polycarbonate, which has a glass transition temperature of about 147° C. (297° F.), it softens gradually above this point and flows above about 155° C. (311° F.). The polycarbonate in sheet form, is heated just above its glass transition temperature, and then is pressure formed between opposing surfaces or thermo formed over a mold using vacuum. If heated to about 155° C. the polycarbonate may be injected into a mold to yield the desired body shape when cooled to a unitary structure.

The method formable polymeric material heated to or above its glass transition temperature, to form a shaped skateboard deck 12 as herein used, means the employment of any type of polymeric material which is then heated just below, at, or above its glass transition temperature, to yield a state in the polymeric material where it may either flow to a mold, or form a pliable planar body for engagement between shaped compressive components, or is formable using thermoforming, or other means for molding or forming a deck 12 in a unitary structure using polymeric materials or combinations thereof. For instance, polycarbonate, or acrylic material, of sheet stock, heated to or above its glass transition temperature to a pliable state, or in solid form and heated to flow to a forming mold, has been employed using the system herein with great success. The resulting deck 12 cooled to form a unitary structure can have multiple parallel and traverse angled sections, or cambered sections, and has excellent flex and light transmission qualities.

It should be noted and anticipated that the shape and formed of the deck 12 using the system herein, can be infinitely varied as deemed suitable by the designer. As such it is to be understood that the depiction of the deck 12 shown in the figures herein, is given merely as an illustrative example of some of the angle sections and combinations and shaped configurations, and should not be considered limiting in any manner.

As shown, the system herein enables the formation of decks 12 with a single camber formation which is widely used, as well as a dual camber formation which yields additional riding and performance characteristics such as flex and rebound and rigidity of the unitary deck 12. Using polycarbonate, or another polymeric material, which is heated to the noted respective temperature to allow it to be pressure molded, thermoformed, or injection molded, the resulting unitary structured deck 12 can also be imparted with dual camber or angled section configurations, and is a significant improvement in the art which has few if any such structures. Conventional decks 12 are generally single camber, non unitary structure. Further such will not communicate light through the body end to end. This is due to the current laminate formation of decks 12 and the formation of the deck 12 using the thermoforming herein, using the truck engagement components herein, allows for such dual and even dual axial camber with traverse cambering in a single deck 12.

With that being said, in accordance with a current preferred mode, the device 10 includes a deck 12 body having a perimeter edge defining an interior of the deck 12 body which is formed by the molding method of heated polymeric material herein. The deck 12 body can be enhanced with a mount 13 for engageable trucks. The mount 13 provides a means for engagement of conventional truck assemblies (baseplate 104) employing conventional hardware 100, 102. However, the compressible and slightly flexible nature of the material used for the mount 13 provides both shock absorption of surface forces to the rider, and the deck.

The mount 13 may be formed as a single or multiple component structure and both provide similar function to the deck 12. In both modes the formed mount 13 is formed of a flexible compressible material which is hard enough to hold the bolts for the truck, but slightly compressible to absorb and dampen shocks from the wheels such as a plastic or polymer with similar qualities to neoprene. Thus the mount 13 isolates the shock and vibration from the wheels on the riding surface from the deck 12 in either mode. In the mode shown in FIGS. 4-9 the mounts 13 engages the deck 12 in a sandwiched engagement with top support members 28, 32 and a bottom support members 29, 33. Once the components are operatively engaged in the aperture formed in the deck 12, the trucks may be engaged to the mounts 13. Further, the mount 13 may be employed with conventional wood decks 12 if they are configured with the appropriate engagement aperture.

FIG. 4 and FIG. 5 show view of preferred modes of the mount 13 where top support members 28, 32, which engage with respective bottom support members 29, 33 which are substantially identical but may vary depending on the recess in the deck 12 and aperture therethrough.

The support members 28, 29, 32, 33 forming the mount 13 are shown as planar (FIG. 4a, 5a), with the top member 28, 32 intended to engaged with or in a recess in the top surface 22 of the deck 12, and the bottom member 29, 33 intended to engage with or in the bottom surface 23 of the deck 12. The deck 12 so engaged is placed in a sandwiched engagement therebetween.

The members 28, 29, 32, 33 include a plurality of clearance apertures 30 configured and spaced so as to be adapted to receive bolt hardware 100 in a conventional pattern for engaging conventional truck assemblies (baseplate 104). Further, it is anticipated that at least one of the top support members 28, 32 can include countersinks 31 as needed for receiving the heads of conventional bolt hardware 100 in a flush mounted engagement (FIG. 9).

As noted, once injection molded, pressure molded, or thermoformed, the deck 12 is preferably provided with cut or preformed apertures 18, and 20, positioned in a central area of the deck 12 between both ends. The apertures both communicate through the deck in conventional locations spaced from each other and each end, for engaging the trucks. This generally includes a front aperture 18 and a rear aperture 20, which are disposed in conventional locations where trucks are engaged, such as that shown in the figures. The mounts 13 are configured with perimeters which are complimentary to the perimeters of the apertures.

Since the trucks and hardware engage the apertures of the formed mount 13, instead of a deck 12, if a user wants to adjust truck positioning, the holes for the truck hardware in the mount 13, or another mount 13, can be re-drilled, and not cause additional holes to be formed in the deck 12 which are not aesthetic and seriously compromise the deck 13 structural integrity. The mounts 13 can be provided in kits with the holes in different positions to allow for a repositioning of the trucks on the deck 13 by changing to a mount 13 with the holes in appropriate spots. Thus the either of the unitary or multi-piece mounts 13 herein, by compressibly engaging a formed deck aperture 18 and 20, allow for great utility in the adjustment in truck placement, not provided conventionally, as well as shock isolation and protection of the deck 12 from impacts.

The apertures 18, 20 communicating through the deck 12 to engage with the mounts 13, are defined by respective circumferential edges 19, 21 formed in the deck 12. The apertures 18 and 20 are sized and shaped to operatively engage with one of the mounts 13 herein disclosed. The mounts 13 provide for the operative communication and engagement of a conventional plurality of bolt hardware 100 to extend through the axis of the deck 13, without any direct physical contact of the bolts 100 with the deck 12 (FIG. 8, 9).

Thus, the truck assembly (baseplate 104) is secured with conventional hardware 100, 102 communicated through the mount 13 be it unitary or of multiple components such as the top 28, 32 and bottom 29, 33 support members, and wheel and truck vibration and impact, is insulated in its communication to the deck 12. Further, the compressive engagement of the bolt hardware 100 is communicated to the surface areas of contact of mount 13 and either the unitary mount 13 or the mount 13 formed of support members 28, 32. A compressive sandwiched engagement can be provided by the compressive force of the truck hardware.

The circumferential edges 19, 21 of the apertures 18, 20 preferably communicate with respective recessed lip portions 24, 26 providing a recessed surface area of contact with the top 28, 32 and bottom support members 29, 33 in the multi-component mount 13. Thus, in the engaged mode shown in FIG. 9, the top support members 28, 32, are positioned below the top 22 surface, and the bottom members 29, 33 are engaged above the bottom surface 23 of the deck 12, to allow the top 28, 30 and bottom 29, 33 members to sit flush with the respective surface of the deck. It is noted that this recess lip, 24, 26 may be employed on one or both of the top 22 and bottom 23 surfaces of the deck 12, however, preferably at least the top surface 22 such that the top support members 28, 32 will sit flush and not protrude from the surface 22 of the deck 12 as is desired for rider safety reasons.

It is envisioned that in some preferred modes, in addition to the single unitary structure mount 13 of figure, 14 which as noted would appear in a sliced view substantially the same as the multi component mount, the support members 28, 29, 32, 33 can be formed from one or a plurality of layers of material.

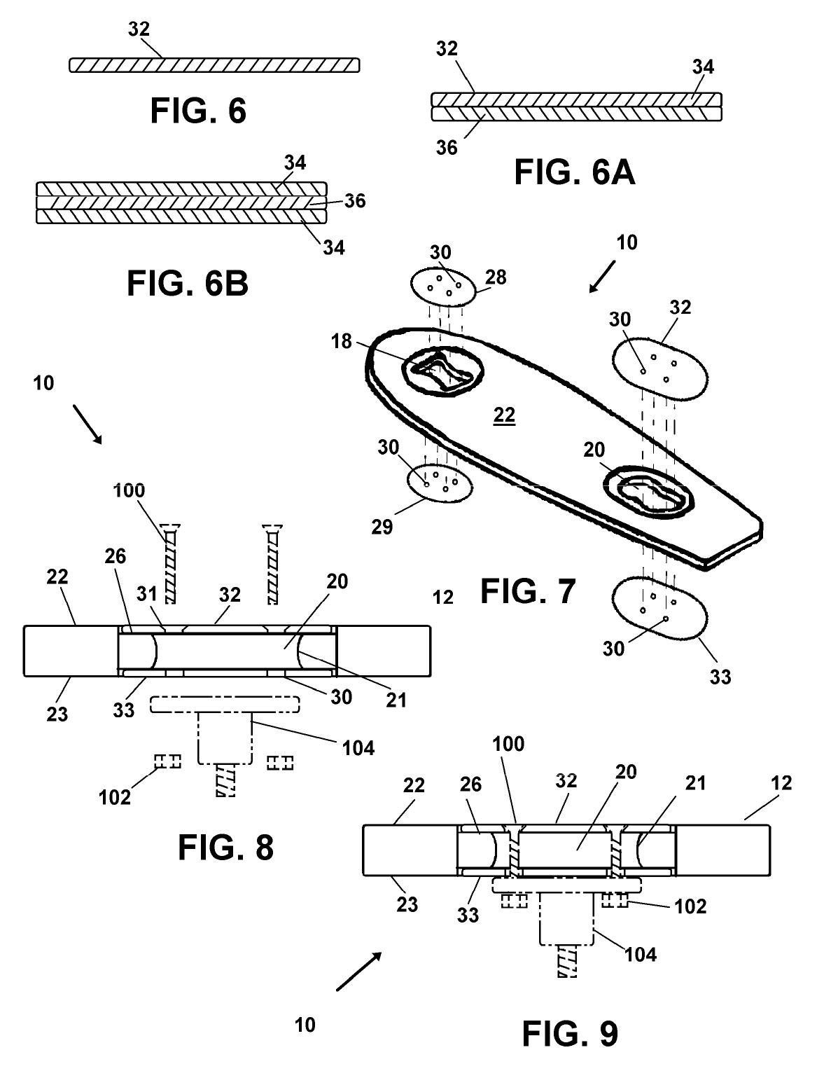

FIG. 6 shows a first preferred mode of a multi component mount 13, showing a cross section of one of the top support members 32 formed from one layer of hard material, such as a hard plastic, or metal such as stainless steal, to provide suitable support without substantial flexure when under the compressive engagement communicated by the secured hardware 100, 102. It is noted and anticipated that the remaining support members 28, 29, 33 may have a similar cross section.

FIG. 6a shows another preferred mode of multi component mount 13 engageable with the thermoformed deck 12 wherein the support member 32 is formed of at least two layers of material. For example, a layer of hard material 36, and a top layer of cushion material 34. Again, the hard material layer 36 can be a metal or hard plastic, and the cushion layer 34 can be a soft rubber, foam, or other suitable material. It is intended that the cushion layer 34 is exposed when engaged to the deck 12, to provide a gripping surface for the users feet when riding the skateboard device 10.

FIG. 6b shows still another mode of a mount 13 showing the support member 32 formed from at least three layers of material. This may include top and bottom cushion layers 34, with a middle layer 36 of hard material, such as metal or hard plastic. Again, the top layer 34 can provide a gripping surface for the user, while the bottom layer 34 can provide a shock absorbing cushion for the support member 32 engaged to the deck 12.

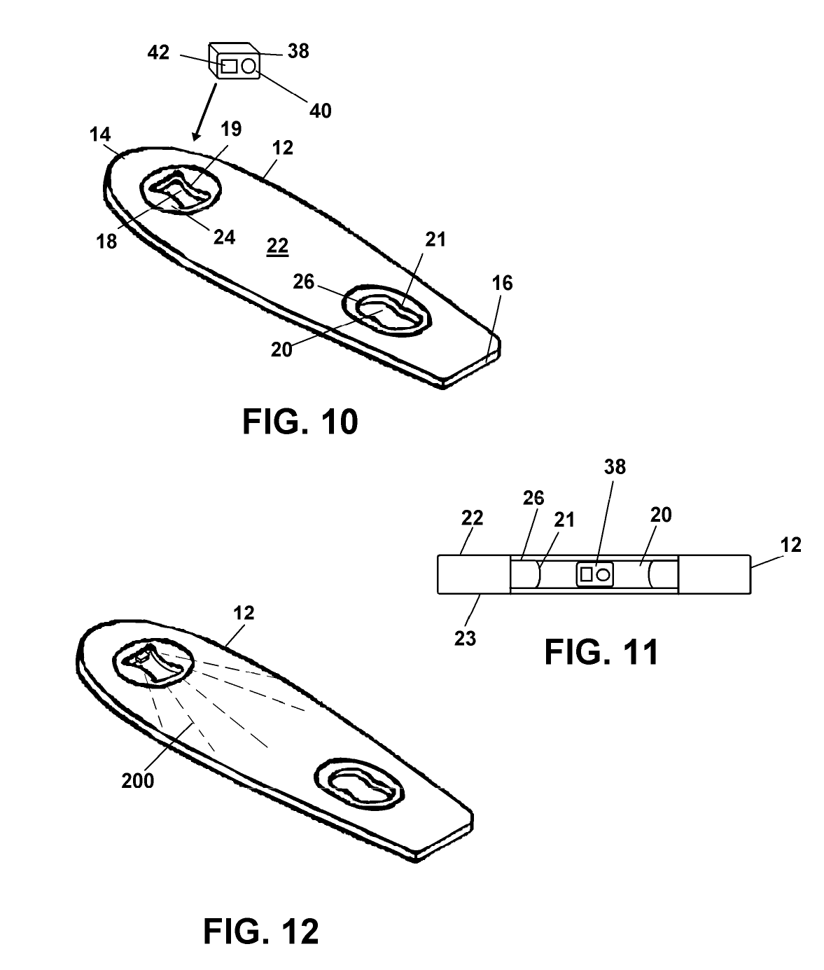

FIG. 10, FIG. 11, and FIG. 12 show another preferred mode of the device 10 wherein the deck 12 may be injection molded, force molded between molds, or thermoformed or otherwise formed using a clear acrylic polycarbonate, or other plastic or polymeric material which may be heated and formed and which cools to a solid unitary structure which is substantially transparent. In this clear or transparent mode, the mount 13 may include one or a plurality of engageable illumination components 38 for projecting light illumination in a fiberoptic fashion, throughout the entire surface area of the deck 12 which as a unitary structure transmits the light especially well.

The illumination component 38 can include a light source, such as an LED 40, spot light, colored light, or other satiable source, and would be powered by a power source, such as a battery 42. It is intended that the illumination component 38 can be engaged within at least one of the apertures 18, 20, such that the illumination component 38 will be hidden and out of the way when the side edge of the mount 13 and/or the support members 28, 29, 32, 33 are in the engaged mode (FIG. 9).

It is noted that illumination of at least one portion of the clear or transparent deck 12, will in a fiberoptic type transmission disperse the light 200 throughout the deck 12 providing an illumination of at least a larger portion of the deck 12 which can cause it to change color, glow, or illuminate the riding surface.

FIG. 12 shows the deck and illumination component in an as-used mode, for illuminating the deck 12.

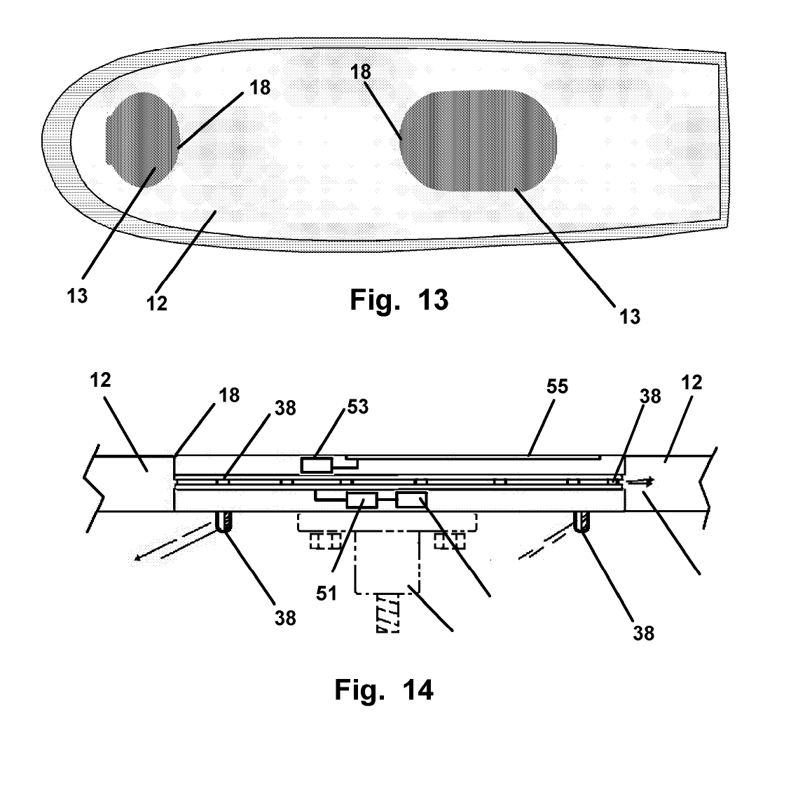

FIG. 13 depicts a top view of a deck 12 subsequent to heat compressive forming, or injection molding, or thermoforming the plastic or polymeric material heated to be formable, to a desired single, dual, or other camber and shape. As shown, the mounts 13 engaged within the formed apertures 18.

As shown in FIG. 14, a number of illumination components 38 are shown. A pair of illumination components 38 are shown projecting below the mount 12 which may be employed to illuminate the riding surface and there could be more of them for such. A plurality of illumination components 38 are placed in the circumference of the mount 13 whereby they may be switched to blink, change color, illuminate in patterns and the like. A controller 51 such as a microprocessor or chip controlled switch, and be employed to switch the illumination components 38 to illuminate. A battery 53 is shown as is a solar charging panel 55. Also shown is a motion sensor 57 such as an accelerometer, which can be employed to work with the controller 51 to change light blinking, patterns, and colors, or the like, according to the speed of the rolling deck 12. The truck 104 is shown engaged with the mount 13 which as noted may be unitary of an elastic material and compressed into the aperture or it may be the sandwiched type mount 13 noted above.

As noted using the mount 13 system herein is employable with conventional laminated decks 12 and works especially well in combination with plastic or polymeric decks 12 formed in unitary structures, to protect them from cracking where the holes for the trucks communicate with the deck.

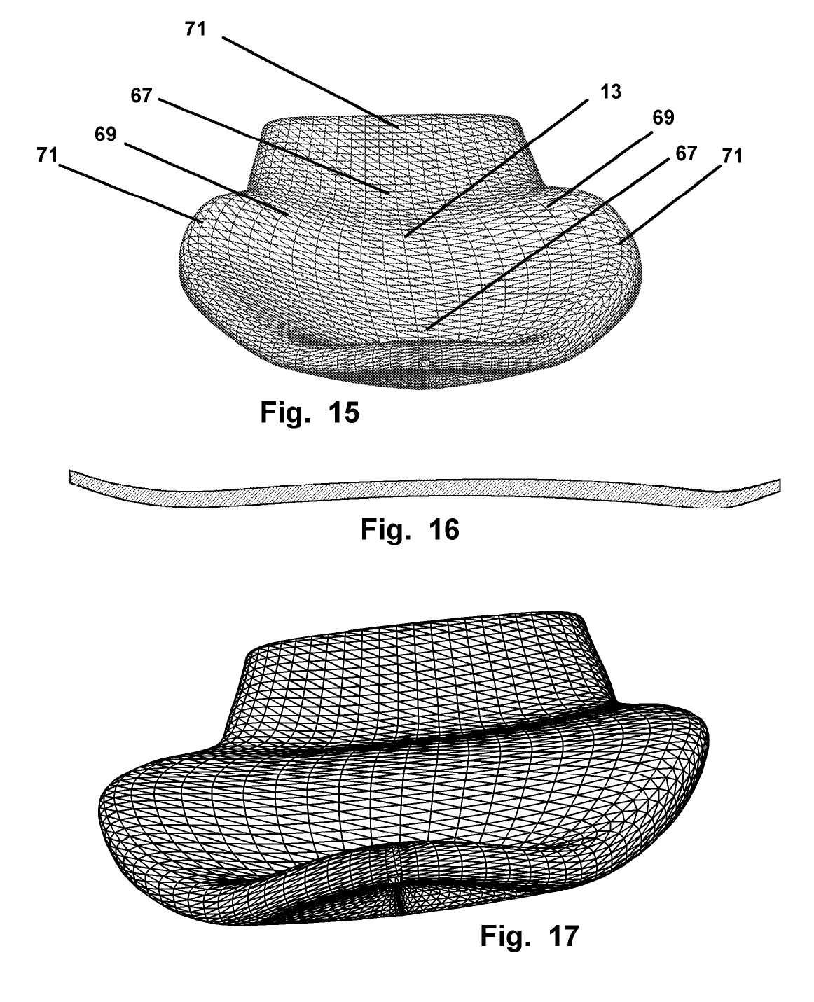

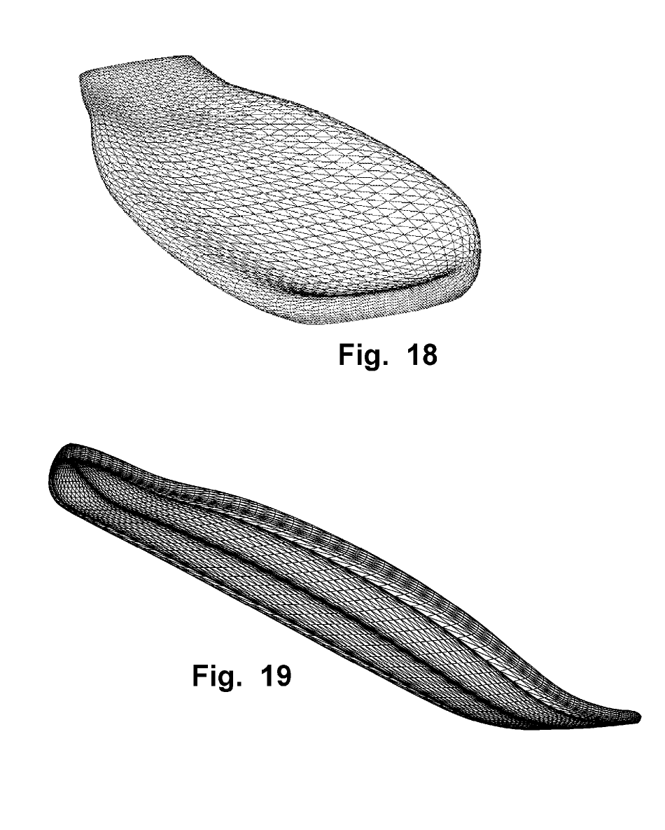

FIG. 15-17 depict shapes achievable using the method herein of forming decks 12 as unitary structures by operatively placing heated plastic or polymeric material such as polycarbonate, in an injection mold, or over a thermoforming mold, or between compressive components which will form the deck 12 therebetween. The opposing compressive mode works especially well with sheet laminate material which is first cut to the deck shape and then pressed into a formed mold in a desired shape. Shown is a dual cambered deck 12 which may be formed using the method herein and which works especially well with the mounts 13. In FIG. 15 the deck is shown with numerous depressions 67 leading to angled side portions 69 and raised portions 71 which the thermoforming of the decks 12 enables by allowing for the formation of dual cambered decks 12. FIGS. 16-17 show alternate views of the dual cambered board of FIG. 15 having different curved or angled sections formed in the deck 12.

FIG. 18 shows a deck 12 formed using the system herein enabled by the mounts 13 described, and having raised side edges and a substantially planar central section. FIG. 19 is a perspective underside view of the FIG. 18.

In the method of deck formation herein, the plastic or polymeric material such as the especially preferred polycarbonate, is heated to the proper temperature to render it reformable, depending upon whether it will be injection molded, or thermoformed, or molded between opposing components. The material is communicated to the mold to form the deck, and once formed in the heated material mode, the deck 12 is allowed to cool into a unitary structure with the single or dual cambered configuration. There after if the apertures 18 and 20 were not formed in an injection mold process, such as when thermoformed, they are cut from the formed deck 12 in the desired positions and with the appropriate perimeter shape and size, to match the mounts 13 if used. If mounts 13 are not to be employed, then the formed decks 12 are drilled for engagement of trucks thereto. The unitary structured deck 12 thereby yielded in the process, has excellent light transmission capabilities as well as excellent flex and rebound characteristics desirable in a deck 12.

Other aspects of the present invention shall be more readily understood when considered in conjunction with the accompanying drawings, and the following detailed description, neither of which should be considered limiting.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A method of forming a skateboard deck from a polymeric material comprising:
at or above a glass transition temperature thereof;
communicating said polymeric material at said formable temperature into a pressurized communication with a mold having a surface said surface having a shape;
allowing said polymeric material to remain in said pressurized communication for a duration of time required for said polymeric material so assume said shape; and
allowing said polymeric material to cool below said glass transition temperature and thereby form said skateboard deck to a unitary structure in a shape of a skateboard deck.

2. The method of claim 1 additionally comprising:
cutting a section of said polymeric material from a planar sheet of said polymeric material;
placing said polymeric material between two opposing mold sections; and
forcing said mold sections toward each other to achieve said pressurized communication, by a sandwiched contact of said mold sections with said section of said polymeric material.

3. The method of claim 1, additionally comprising:
melting said polymeric material into a communicable fluid stream of said polymeric material, by heating a said formable temperature in excess of a said glass transition temperature of said polymeric material;
communicating said fluid stream of said polymeric material in said pressurized communication, into an injection mold having an interior surface of a mold cavity to form said skateboard deck, as a unitary structure, upon subsequent to said cooling below said glass transition temperature

4. The method of claim 1, additionally comprising:
forming a pair of apertures communicating throughout said skateboard deck;
inserting a compressible mount into each of said pair of apertures to form a biased engagement of a perimeter of said mount with portions of a respective perimeter edge of each of said pair of apertures; and
forming apertures through said compressible mount, adapted for engagement with nuts and bolts employed for engagement of a skateboard truck thereto.

5. The method of claim 2, additionally comprising:
forming a pair of apertures communicating throughout said skateboard deck;
inserting a compressible mount into each of said pair of apertures to form a biased engagement of a perimeter of said mount with portions of a respective perimeter edge of each of said pair of apertures; and
forming apertures through said compressible mount, adapted for engagement with nuts and bolts employed for engagement of a skateboard truck thereto.

6. The method of claim 3, additionally comprising:
forming a pair of apertures communicating throughout said skateboard deck;
inserting a compressible mount into each of said pair of apertures to form a biased engagement of a perimeter of said mount with portions of a respective perimeter edge of each of said pair of apertures; and
forming apertures through said compressible mount, adapted for engagement with nuts and bolts employed for engagement of a skateboard truck thereto.

7. The method of claim 4, additionally comprising:
positioning light emitters at positions along said perimeter of said mount;
positioning an electrical power source for said light emitters in said mount;
positioning a switch to connect said light emitters to said power source whereby light emitted from said light emitters travels through said unitary structure forming said skateboard deck, providing an illumination of said deck form one or both respective perimeters of said respective mounts.

8. The method of claim 5, additionally comprising:
positioning light emitters at positions along said perimeter of said mount;
positioning an electrical power source for said light emitters in said mount;
positioning a switch to connect said light emitters to said power source whereby light emitted from said light emitters travels through said unitary structure forming said skateboard deck, providing an illumination of said deck form one or both respective perimeters of said respective mounts.

9. The method of claim 6, additionally comprising:
positioning light emitters at positions along said perimeter of said mount;
positioning an electrical power source for said light emitters in said mount;
positioning a switch to connect said light emitters to said power source whereby light emitted from said light emitters travels through said unitary structure forming said skateboard deck, providing an illumination of said deck form one or both respective perimeters of said respective mounts.

10. The method of claim 1, additionally comprising:
employing polycarbonate as said polymeric material.

11. The method of claim 2, additionally comprising:
employing polycarbonate as said polymeric material.

12. The method of claim 3, additionally comprising:
employing polycarbonate as said polymeric material.

13. A skateboard deck comprising:
a planar sheet of polymeric material formed as a unitary structure;
a pair of apertures communicating through said planar sheet, each defined by a perimeter edge;
compressible mounts, positioned within each of said pair of apertures to an engaged position;
said circumferential edge of each respective said mount exerting a biasing force toward said perimeter edge of a said aperture; and
said biasing force providing means to urge said circumferential edge of said mounts in a frictional contact against said perimeter edge of said apertures to maintain said compressible mounts in said engaged position.

14. A skateboard deck of claim 13 additionally comprising:
one or a plurality of light emitters positioned on said circumferential edge of one or both of said compressible mounts;
said light emitters operatively engaged with a power source engaged with said mount;
light emitted from said light emitters communicating through said unitary structure of polymeric material and causing an illumination of said skateboard deck.

15. A skateboard deck of claim 14 additionally comprising:
said polymeric material comprising polycarbonate.
